(19) United States
(12) Patent Application Publication
(10) Pub. No.: US 2022/0163806 A1
(43) Pub. Date: May 26, 2022

(54) EYEGLASS DEVICE WITH TOUCH SENSOR AND METHOD OF USE

(71) Applicant: Digital Community LLC, Sherman Oaks, CA (US)

(72) Inventor: David CHAUM, Sherman Oaks, CA (US)

(21) Appl. No.: 17/584,617

(22) Filed: Jan. 26, 2022

Related U.S. Application Data
(63) Continuation of application No. 14/612,556, filed on Feb. 3, 2015, now abandoned.
Application No. 14/612,556 is a continuation of application No. 12/579,356, filed on Oct. 14, 2009, now abandoned.
Application No. 12/579,356 is a continuation-in-part of application No. PCT/US2009/002174, filed on Apr. 6, 2009.
Application No. PCT/US2009/002174 is a continuation-in-part of application No. PCT/US2009/002182, filed on Apr. 6, 2009.
(60) Provisional application No. 61/077,340, filed on Jul. 1, 2008.
(60) Provisional application No. 61/057,869, filed on Jun. 1, 2008.
(60) Provisional application No. 61/056,056, filed on May 26, 2008.
(60) Provisional application No. 61/050,602, filed on May 5, 2008.
(60) Provisional application No. 61/050,189, filed on May 2, 2008.
(60) Provisional application No. 61/045,367, filed on Apr. 16, 2008.
(60) Provisional application No. 61/042,766, filed on Apr. 6, 2008.
(60) Provisional application No. 61/042,764, filed on Apr. 6, 2008.
(60) Provisional application No. 61/042,762, filed on Apr. 6, 2008.
(60) Provisional application No. 61/232,426, filed on Aug. 8, 2009.
(60) Provisional application No. 61/230,744, filed on Aug. 3, 2009.
(60) Provisional application No. 61/180,982, filed on May 26, 2009.
(60) Provisional application No. 61/180,101, filed on May 20, 2009.
(60) Provisional application No. 61/173,700, filed on Apr. 29, 2009.
(60) Provisional application No. 61/171,168, filed on Apr. 21, 2009.
(60) Provisional application No. 61/169,708, filed on Apr. 15, 2009.
(60) Provisional application No. 61/142,347, filed on Jan. 3, 2009.
(60) Provisional application No. 61/110,591, filed on Nov. 2, 2008.

(51) Int. Cl. G02B 27/01; G02B 27/00; G09G 3/02

(52) U.S. Cl. CPC G02B 27/0172; G02B 27/0093; G09G 3/2003; G09G 3/02; G02B 27/0075; G02B 27/017

(57) ABSTRACT

An eyeglass device includes an eyeglass frame having a pair of side arms and a pair of optics. A camera and one or more speakers are supported by the eyeglass frame. A touch sensor is supported by the eyeglass frame for at least controlling volume of the one or more speakers.

### CROSS-REFERENCE TO RELATED APPLICATION(S)

This application is a continuation of U.S. Ser. No. 14/612,556, entitled “Near to Eye Display System, Proximal Optic Therefore and Method for Displaying Images”, filed Feb. 3, 2015, which is a continuation of U.S. Ser. No. 12/579,356, entitled “Near to Eye Display and Appliance”, filed Oct. 14, 2009, which is a continuation in part of PCT Application Nos. PCT/US2009/002174, entitled “Proximal Image Projection System,” filed Apr. 6, 2009 and PCT/US2009/002182, entitled “Proximal Image Projection System,” filed Apr. 6, 2009, the entire contents of which are incorporated by reference herein. This application claims priority to and the benefit of U.S. Provisional Application Nos. 61/042,762, entitled “Proximal-Screen Image Construction,” filed Apr. 6, 2008; 61/042,764, entitled “Eyeglasses Enhancements,” filed Apr. 6, 2008; 61/042,766, entitled “System for Projecting Images into the Eye,” filed Apr. 6, 2008; 61/045,367, entitled “System for Projecting Images into the Eye,” filed Apr. 16, 2008; 61/050,189, entitled “Light Sourcing for Image Rendering,” filed May 2, 2008; 61/050,602, entitled “Light Sourcing for Image Rendering,” filed May 5, 2008; 61/056,056, entitled “Mirror Array Steering and Front-Optic Mirror Arrangements,” filed May 26, 2008; 61/057,869, entitled “Eyeglasses Enhancements,” filed Jun. 1, 2008; 61/077,340, entitled “Laser-Based Sourcing and Front-Optic,” filed Jul. 1, 2008; 61/110,591, entitled “Foveated Spectacle Projection Without Moving Parts,” filed Nov. 2, 2008; 61/142,347, entitled “Directed Viewing Waveguide Systems,” filed Jan. 3, 2009; 61/169,708, entitled “Holographic Combiner Production Systems,” filed Apr. 15, 2009; 61/171,168, entitled “Proximal Optic Curvature Correction System,” filed Apr. 21, 2009; 61/173,700, entitled “Proximal Optic Structures and Steerable Mirror Based Projection Systems Therefore,” filed Apr. 29, 2009; 61/180,101, entitled “Adjustable Proximal Optic Support,” filed May 20, 2009; 61/180,982, entitled “Projection of Images into the Eye Using Proximal Redirectors,” filed May 26, 2009; 61/230,744, entitled “Soft-Launch-Location and Transmissive Proximal Optic Projection Systems,” filed Aug. 3, 2009; and 61/232,426, entitled “Soft-Launch-Location and Transmissive Proximal Optic Projection Systems,” filed Aug. 8, 2009, the entire contents of which are incorporated by reference herein.

### FIELD OF THE INVENTION

An eyeglass device includes a touch sensor for controlling components contained on the eyeglass frame of the eyeglass device.

### BACKGROUND OF THE INVENTION

Eyeglass devices are worn by millions and millions of people. There are also eyeglass devices that incorporate different components as is disclosed in U.S. Pat. No. 6,349,001, which is herein incorporated by its entirety, particularly for its teachings of the incorporation of the various componentry into the eyeglass frame.

However, the ways that the componentry is controlled needs improvement and the present invention responds to this need.

### SUMMARY OF THE INVENTION

The invention is an improvement in eyeglass devices in terms of components like a speaker or camera associated therewith and control thereof.

In one embodiment, the eyeglass device includes an eyeglass frame having a pair of side arms and a pair of optics. The eyeglass frame supports a camera and one or more speakers. A touch sensor is provided on the eyeglass frame to allow for at least controlling volume of the one or more speakers supported by the eyeglass frame. The touch sensor can be located on one of the pair of side arms.

In another embodiment, the eyeglass device includes an eyeglass frame, a pair of optics, and a pair of side arms. Also provided is a camera and/or one or more speakers, and a touch sensor on the eyeglass frame for controlling at least one of the camera and the one or more speakers. For this embodiment, the touch sensor is on one of the pair of side arms.

The invention also includes the use of the eyeglass device, wherein a user dons the eyeglass device and touches the sensor to control at least the volume of the speakers located on the eyeglass device.

### BRIEF DESCRIPTION OF THE DRAWINGS

FIGS. 1A-C are plan drawings of configurations for wearer gesture, proximity and touch sensing.

FIGS. 2A-C are plan drawings of configurations for audio transducers.

FIGS. 3A-D are plan drawings of configurations for mechanical and signal connections.

FIGS. 4A-B are top-view drawings of external connected auxiliary device configurations.

FIG. 5A is a side elevational view of an electronic eyeglass device according to an embodiment of the invention, in an unfolded position.

FIG. 5B is a side elevational view of a side arm of an eyeglass device according to another embodiment of the invention.

FIG. 5C is a front elevational view of an electronic eyeglass device according to another embodiment of the invention, in an unfolded position.

FIG. 6 is a front view of an electronic eyeglass device according to an embodiment of the invention, in a folded position.

FIG. 7 is a front view of an electronic eyeglass device according to an embodiment of the invention, in a folded position.

FIG. 8 is a front view of an electronic eyeglass device according to an embodiment of the invention, in a folded position.

FIG. 9A is a front view of an electronic eyeglass device according to an embodiment of the invention, in a folded position.

FIG. 9B is a side view of the device of FIG. 9A, in an unfolded position.

FIG. 9C is a top view of the device of FIG. 9A, in an unfolded position.

FIG. 10A is a partial top view of an electronic eyeglass device according to an embodiment of the invention.

FIG. 10B is a partial front view of the device of FIG. 10A.

FIG. 10C is a cross-sectional view of an optic lens according to an embodiment of the invention.

FIG. 10D is a partial front view of an eyeglass device according to another embodiment of the invention.

FIG. 10E is a side view of the eyeglass device of FIG. 10D.

FIG. 10F is a partial top view of the eyeglass device of FIG. 10D.

FIG. 11A is a partial top view of an electronic eyeglass device according to an embodiment of the invention.

FIG. 11B is a partial top view of an electronic eyeglass device according to another embodiment of the invention.

FIG. 11C is a partial top view of an electronic eyeglass device according to another embodiment of the invention.

FIG. 11D is a partial front view of an electronic eyeglass device according to an embodiment of the invention.

FIG. 12A is a partial side view of a side arm of an electronic eyeglass device according to an embodiment of the invention.

FIG. 12B is a schematic view of a coil according to the embodiment of FIG. 12A.

FIG. 12C is a partial side view of the device of FIG. 12A with a boot, according to an embodiment of the invention.

FIG. 12D is a cross-sectional view of the device of FIG. 12C, taken along the line 12D.

FIG. 12E is a front view of an electronic eyeglass device according to an embodiment of the invention.

FIG. 12F is a top view of a storage case according to an embodiment of the invention.

FIG. 12G is a top view of an electronic eyeglass device according to an embodiment of the invention, with a lanyard.

FIG. 12H is a top view of an electronic eyeglass device according to another embodiment of the invention, with a lanyard.

FIG. 13A is a side view of a side arm of an electronic eyeglass device according to an embodiment of the invention.

FIG. 13B is a side view of an electronic eyeglass device with a replacement side arm, according to an embodiment of the invention.

FIG. 13C is a close-up view of a hinge connection according to the embodiment of FIG. 13B.

FIG. 14A is a side view of an attachment unit for an electronic eyeglass device according to an embodiment of the invention.

FIG. 14B is a side view of a traditional eyeglass frame, for use with the attachment unit of FIG. 14A.

FIG. 14C is a side view of an attachment unit according to an embodiment of the invention.

FIG. 14D is a cross-sectional view of a side arm and attachment unit according to an embodiment of the invention.

FIG. 15 is a block diagram of various components according to an exemplary embodiment of the invention.

### DETAILED DESCRIPTION OF THE INVENTION

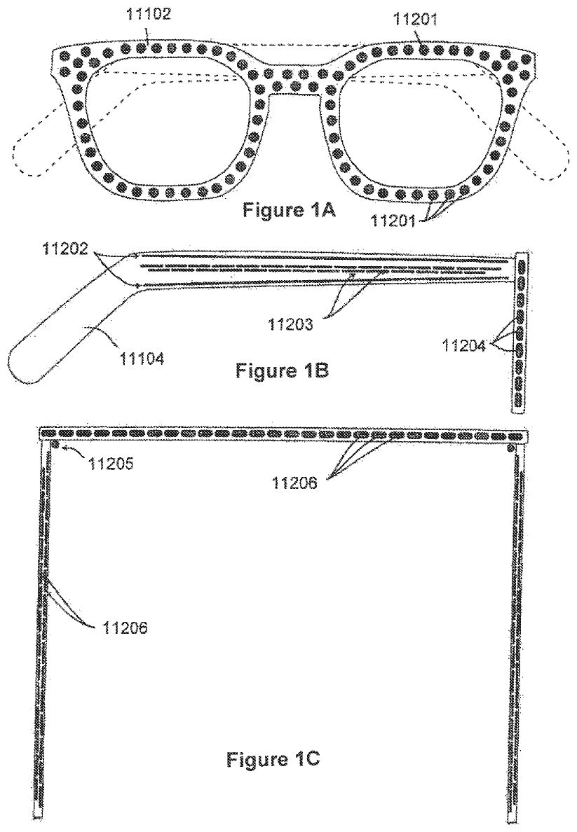

Referring to FIG. 1A, shown are exemplary placement of sensors 11201 on the frame front of a pair of eyeglasses 11102. One common sensing technology is so-called “capacitive,” as is well known in the sensing art and implemented in chips such as the Analog Devices AD7142 and the Quantum QT118H.

Referring to FIG. 1B, shown are some other example placements of various sensors. For instance, two converging lines 11202 are shown on the temple arm 11104, to suggest proximity sensing and so-called “slider” sensing, also shown in the example of capacitive sensors. Additionally, positional sensors are shown as two alternating patterns of strips 11203, such as would be understood to detect one or more touch positions as well as sliding. Furthermore, the edge of the frame front is shown with sensors 11204 arrayed around it.

Referring to FIG. 1C, a top and/or bottom view of an eyeglasses frame arrayed with sensors is shown. The hinges 11205 can be seen connecting the frame front to the earpiece sidearm. Sensors 11206 line the edges including the parts shown.

Turning to FIGS. 1A-C, exemplary configurations for audio transducers 11301 are shown in accordance with the teachings of the present invention. One example type of audio transducer is a microphone. Another is a so-called “bone conduction” device that sends and/or receives sound through bones of the skull. For example, sound is rendered audible to the wearer by sound conducted to the inner ear and/or spoken utterances of the wearer are picked up from the skull.

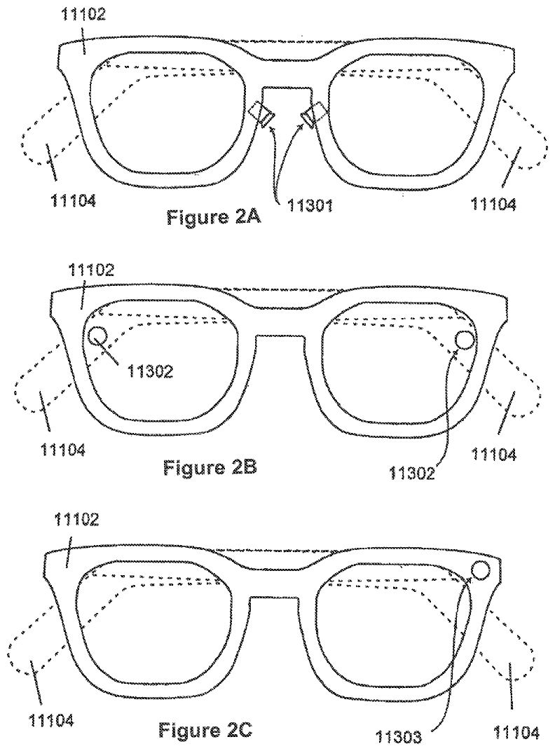

Referring to FIG. 2A, shown is an advantageous and novel arrangement in which the “bridge” portion of the eyeglass frame structure substantially rests on the nose bone of the wearer and these points of contact are used for bone conduction of sound. For instance, the transducers 11301 may rest directly on the nose, as shown for clarity, or they may be configured to conduct through other elements, such as pads or a metal bridge. A pair of transducers 11301 is shown for clarity and possibly for stereo effect. However, a single transducer is also anticipated.

Referring to FIG. 2B, shown is an alternate example placement of a bone conduction transducer 11302. It is mounted on the inside of the temple 11104 so that it contacts the skull substantially behind the ear as shown. Some pressure is preferably provided for good sound conduction.

Referring to FIG. 2C, shown is an audio and/or imaging pickup transducer 11303. In some examples it is aimed at detecting sounds in the environment of the wearer as well as optionally utterances made by the wearer. Multiple such sensors and arrays of such sensors are anticipated. In some examples, a sound is generated, such as to alert people, help the owner find the spectacles, and/or for ultrasonic ranging or the like. In other examples the sensor is a video camera or night vision camera, aimed forward, sideways, or even backwards.

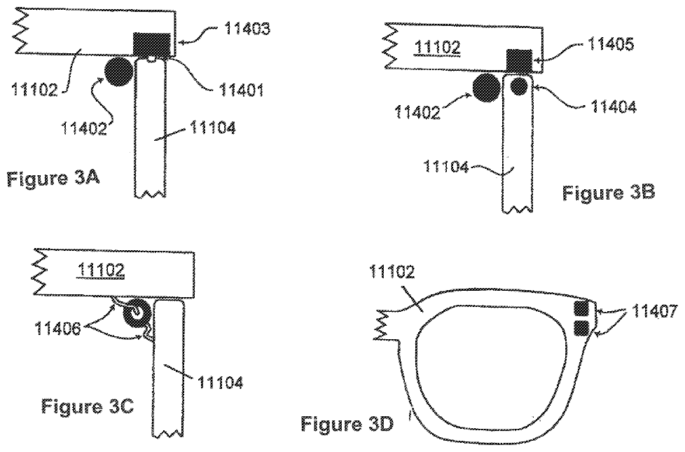

Turning to FIGS. 3A-D, exemplary configurations for mechanical and signal connection and power switching between sidearm and frame front are shown in accordance with the teachings of the present invention. FIGS. 3A-B are primarily directed at so-called “on/off” switching at the hinge. FIGS. 3C-D are primarily directed at power provision through the hinges. However, the two aspects are related in some examples, such as where a slip-coupling includes a power switching capability or where switch contacts are used for providing power.

Referring to FIG. 3A, shown is a section through the horizontal of the right corner of a pair of glasses 11102 configured with a mechanical button 11401 at the junction between the sidearm 11104 and the frame front. In this example, the hinge 11402 can be whatever type including a standard hinge. A switch body is shown included in the frame front with a button 11401 protruding in the direction of where the sidearm 11104 contacts the frame in the open wearable position. When the frame is being worn, or in some examples when it is lying open, the button 11401 is substantially pushed by the end of the sidearm 11104 and power is supplied for various purposes, such as those described elsewhere here. When the frame is not open, however, such as folded, power is substantially cut off. In some examples the spring-loaded button 11401 comprises one or more contacts between the two components of the frame. Such switches 11403 are known to be small, such as the DH Series manufactured by Cherry or the D2SW-P01H by Omron.

Referring to FIG. 3B, an alternate shutoff switch arrangement is shown comprising a so-called “reed switch” 11404 and permanent magnet 11405. Such switches are known to be small, such as that disclosed by Torazawa and Arimain in “Reed Switches Developed Using Micro-machine Technology,” Oki Technical Review, p 76-79, April 2005. When the frame is open, the magnet is sufficiently close to activate the switch, as is known. When the frame is closed, the magnet is far enough away and/or oriented such that the switch closes.

Referring to FIG. 3C, an arrangement allowing wire conductors 11406 to pass through an eyeglasses hinge is shown also in horizontal section. The conductors pass through a substantially hollow hinge. In some examples the conductors can be completely hidden, such as disclosed for doors by U.S. Pat. No. 4,140,357, titled “Electric hinge,” and issued to Francis T. Wolz et al. on Feb. 20, 1979. In other examples, the conductors are in the form of a ribbon and may not pass through the hinge.

Referring to FIG. 3D, a plan view of a single eye of a frame front including hinge parts 11407 is shown. There are two example hinge parts 11407, one for each of separate parts of an electrical circuit. The parts are substantially separate hinge components, cooperating to form a substantially adequately strong hinge assembly. However, they are mounted to substantially insulating material, such as plastic resin from which the frame is formed. Each hinge part forms in effect a so-called slip coupling and, as is known for such couplings, such as disclosed in U.S. Pat. No. 3,860,312, titled “Electric slip coupling,” and issued to Frank Gordon Jr. on Jan. 14, 1975, can have provisions to interrupt or cut off power in certain ranges of angular positions.

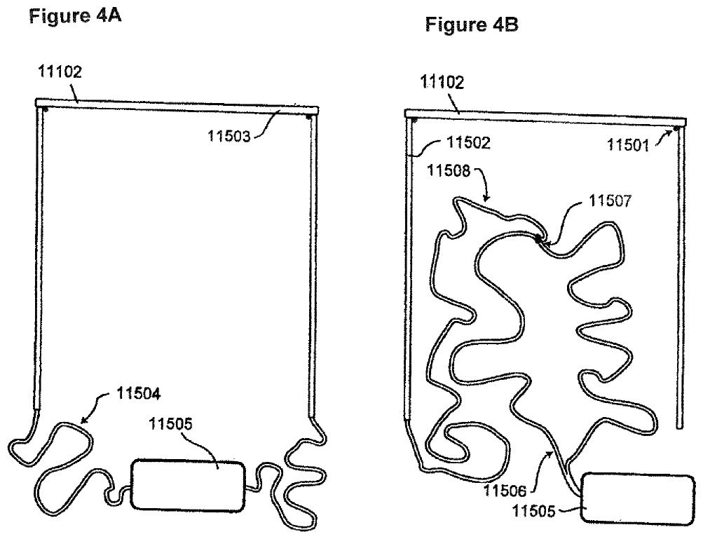

Turning to FIGS. 4A-B, exemplary external connected auxiliary device configurations are shown in accordance with the teachings of the present invention. Two examples are shown in substantially similar plan view with the eyeglasses fully open and viewed from the top. The hinges 11501 can be seen along their axis of rotation joining the temples 11502 to the front face 11503.

Referring to FIG. 4A, a so-called “retainer” cord 11504 arrangement is shown. Ends of each cord are shown emanating from respective ends of corresponding temple arms 11502. In some examples, the connection to the arm 11502 is detachable, such as a connector not shown for clarity. In some particular examples the cords are detachable with low force in substantially any direction, such as by a magnetic connector as are known. Another example is the rubber ring clips currently used, but where each clip provides a contact for a different part of a circuit.

The “payload,” 11505 shown configured between the two cords and substantially flat for convenience in wearing, may perform multiple functions. In one example it performs a cushioning role; in another it is decorative. In further example functions, however, it includes component parts that support or augment functions of the glasses. For instance, it may contain power storage or generation such as batteries that supply power to the glasses, whether for charging onboard power storage or for operation. Another example is memory for content or a connection through which memory devices and/or other interface devices can be accessed. In still another example, a radio transceiver is included. Yet further examples include audio microphones to augment sound capture and additional touch panel surfaces, such as those described with reference to FIGS. 2A-C.

Moreover, whatever functions may be performed by the payload 11505 configured in a tethered mode, may also be performed by a wirelessly connected payload, such as one connected by radio frequency, optical, audio, or other communication technologies and wherever attached or carried on the body or among the accessories of the wearer. For instance, a belt buckle, skin patch, portable phone/computer, wristwatch, or the like may serve at least in part as such a payload. A wearer, as an example, may input selections or other information by gesturing near and touching such a payload while receiving visual feedback of their gestures and touches through the glasses display capability.

Referring to FIG. 4B, a tethered necklace configuration 11506 is shown as another example. The “feed” 11508 tethers, via a connector 11507, to the necklace, which includes the payload. Again, the connector may be detachable for convenience. The necklace 11506 may server as an antenna itself.

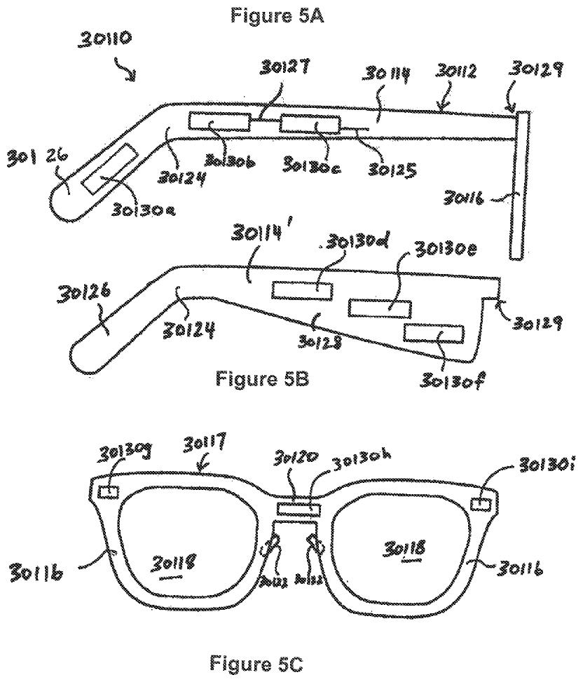

An embodiment of the invention is shown in FIGS. 5A-C. FIG. 5A shows a head-worn electronic device 30110 including an eyeglass frame 30112. The eyeglass frame 30112 includes first and second temples or side arms 30114 (only one of which is visible in the side view of FIG. 5A) and first and second optic frames 30116 (only one of which is visible in the side view of FIG. 5A). The optic frame 30116 may be referred to in the industry as the “eye” of the eyeglass frame. The side arms 30114 are connected to the optic frame 30116 by a hinge 30129. Each optic frame 30116 supports an optic 30118 (see FIG. 5C), which may be a lens or glass or mirror or other type of reflective or refractive element. The frame 30112 also includes a nose bridge 30120 which connects the two optic frames 30116, and two nose pads 30122 that are mounted on the optic frames and that rest on either side of the wearer's nose. The two optic frames 30116 and nose bridge 30120 make up the front face 30117 of the frame 30112. Each side arm 30114 includes an elbow 30124 where the arm curves or bends to form an ear hook 30126 which rests behind the wearer's ear.

As shown in FIGS. 5A-5C, the eyeglass frame 30112 includes various electrical and/or optical components 30130a, 30130b, 30130c, etc. supported by the frame 30112 and powered by electricity and/or light. The components 30130 can be MEMS (microelectromechanical systems). In FIG. 5A, the electrical/optical components 30130 are supported by the side arm 30114. The electrical/optical components 30130 may be mounted within the side arm 30114, under the top-most layer of the side arm, such as under a top plastic cover layer. Alternatively or in addition, the components 30130 may be mounted to the side arm 30114 by adhesive, or by printing the electrical/optical components onto a substrate on the side arm 30114, or by any other suitable method. The components 30130 can be spaced out along the side arm 30114 as necessary depending on their size and function. In FIG. 5B, electrical/optical components 30130 are shown supported on the wing 30128 of the side arm 30114′, and they may be located as necessary according to their size and function. In FIG. 5C, the electrical/optical components 30130 are supported by the two optic frames 30116 and the nose bridge 30120. The necessary conductors 30127 such as wires or circuit board traces are integrated into the frame 30112 to connect and power the various electrical/optical components 30130 at their various locations on the frame. An antenna 30125 can also be connected to one or more components 30130.

The components of the frame 30112 can take on various sizes and shapes. For example, an alternate side arm 30114′, shown in FIG. 5B, includes a wing 30128 that extends down below the hinge 30129 and increases the area of the side arm 30114′. The larger side arm 30114′ can support more electrical/optical components 30130 and/or can allow the components 30130 to be spaced apart. In other embodiments the side arm 30114 and/or optic frame 30116 may have other shapes and sizes, including different diameters, thicknesses, lengths, and curvatures.

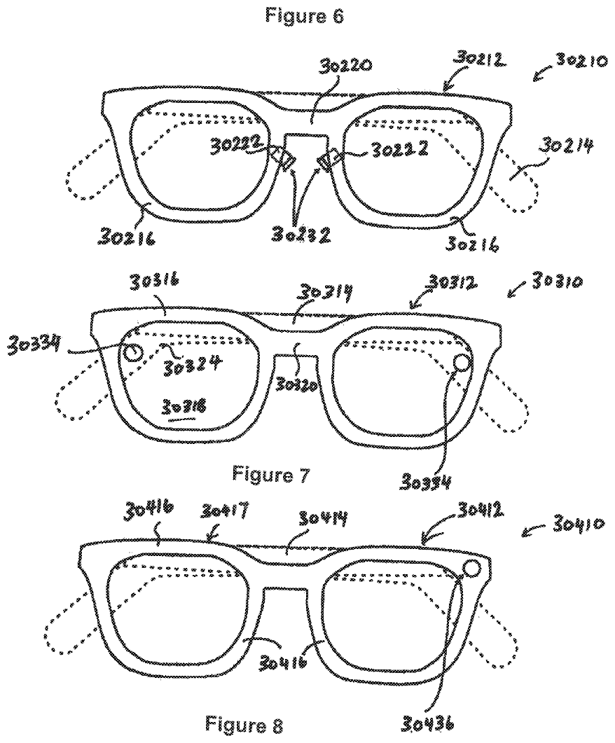

Particular locations on the eyeglass frame 30112 have been discovered to be especially advantageous for certain electrical/optical components. A few examples will be discussed. In FIG. 6, an embodiment is shown in which an eyeglass frame 30212 includes electrical/optical components 30232 mounted on the nose pads 30222 of the eyeglass frame 30212. In one embodiment, the electrical/optical components 30232 mounted on the nose pads 30222 are bone conduction devices that transmit audio signals to the wearer by vibration transmitted directly to the wearer's skull. Bone conduction devices transmit sound to the wearer's inner ear through the bones of the skull. The bone conduction device includes an electromechanical transducer that converts an electrical signal into mechanical vibration, which is conducted to the ear through the skull. In addition to transmitting sound through vibration to the user, the bone conduction device can also record the user's voice by receiving the vibrations that travel through the wearer's skull from the wearer's voice.

Thus, in one embodiment, the electrical/optical components 30232 include bone conduction transducers that transmit and receive vibrations to transmit and receive sound to and from the wearer. These bone conduction devices may be mounted anywhere on the frame 30212 that contacts the wearer's skull, or anywhere that they can transmit vibrations through another element (such as a pad or plate) to the user's skull. In the embodiment of FIG. 6, the devices are mounted on the nose pads 30222 and directly contact the bone at the base of the wearer's nose. The inventor has discovered that this location works well for transmitting sound to the wearer as well as receiving the vibrations from the wearer's voice. Bone conduction devices operate most effectively when they contact the user with some pressure, so that the vibrations can be transmitted to and from the skull. The nose pads provide some pressure against the bone conduction devices, pressing them against the user's nose, due to the weight of the eyeglass devices sitting on the nose pads. At this location, the bone conduction devices can transmit sound to the user and can pick up the user's voice, without picking up as much background noise as a standard microphone, since the user's voice is coming directly through the skull.

The eyeglass frame 30212 can transmit sounds such as alerts, directions, or music to the wearer through the electrical/optical components 30232 and can also receive instructions and commands from the user through the same electrical/optical components 30232. In other embodiments, the electrical/optical components 30232 mounted on the nose pads 30222 may be devices other than bone conduction devices. For example, in one embodiment these components 30232 are standard microphones, used to pick up the user's voice as it is spoken through the air, rather than through the skull. Two components 30232 are shown in FIG. 6, such as for stereo sound, but in other embodiments only one is provided.

In another embodiment of the invention, shown in FIG. 7, an eyeglass frame 30312 includes an electrical/optical component 30334 located at about the elbow 30324 of one or both side arms 30314. This electrical/optical component 30334 may be, for example, an audio output transducer, such as a speaker, which creates an audio output. The location of the electrical/optical component 30334 near the elbow 30324 of the side arm 30314 positions the electrical/optical component 30334 near the wearer's ear, so that the audio output can be heard by the wearer at a low volume. The electrical/optical component 30334 could also be a bone conduction device, as described previously, that contacts the wearer's head just behind the ear and transmits vibrations to the wearer's inner ear through the skull. In FIG. 7, the electrical/optical component 30334 is shown on the inside surface of the side arm 30314, the surface that faces the wearer when the eyeglass frame 30312 is worn. In another embodiment, an electrical/optical component can be supported on the outside surface of the side arm, facing away from the user, such as, for example, the electrical/optical components 30130 shown in FIG. 5A.

In another embodiment of the invention, shown in FIG. 8, an eyeglass frame 30412 includes an electrical/optical component 30436 located on one or both optic frames 30416 on the front face 30417. For example, the component 30436 may be a camera or other image sensor located at the top outer corner of the optic frame 30416. At this location, the camera can face forward from the wearer and record video or take photographs of the scene in front of the wearer's field of view. Alternatively, the component 30436 could face rearward to take video or photographs of the scene behind the wearer. Although only one electrical/optical component 30436 is shown in FIG. 8, on one of the two optic frames 30416, another component may be located on the other optic frame 30416 as well. Other possible examples for the electrical/optical component 30436 are described more fully below.

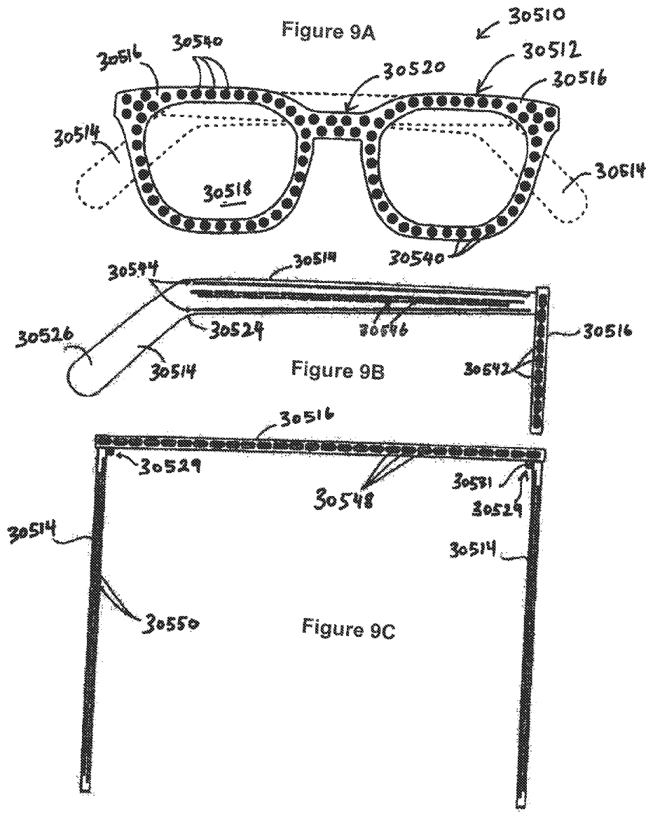

Another embodiment of the invention is shown in FIGS. 9A-9C. As shown in FIG. 9A, an eyeglass frame 30512 includes electrical/optical components 30540 spaced around the front of the two optic frames 30516. In this embodiment, the electrical/optical components 30540 may be sensors that obtain input from the user. For example, they may be touch sensors that send a signal to a computer processor or other device on the eyeglass device 30510 each time the user touches one of the sensors, or they can be pressure sensitive sensors, static electricity sensors, strain gages, or many other types of sensors or components as described more fully below. The sensors 30540 can be spaced apart along each optic frame 30516, encircling the optic 30518, and along the nose bridge 30520. The input from all of the sensors 30540 can be correlated by the computer processor to sense movement of the user's fingers along the frame 30516. For example, a user could move a finger along one of the optic frames 30516 in a circle, around the optic 30518, and the computer processor can sense this movement as the user moves from one sensor 30540 the next adjacent sensor 30540. Different patterns of tactile input can be recognized by the computer processor as different commands from the user. For example, tactile contact along the sensors 30540 in a counter-clockwise direction around one of the optic frames 30516 can indicate to the computer processor to provide a particular response, such as to have a camera (for example, component 30436 in FIG. 8) zoom in or focus, and tactile contact in the clockwise direction can indicate to the computer processor to provide a different response, such as to zoom out or refocus. The user may touch a sensor 30540 on the bridge 30520 to turn the camera on or off. These are just a few examples of the interaction between the user and the electrical/optical components through the touch sensors.

FIG. 9B shows a side view of the eyeglass frame 30512, showing electrical/optical components 30542 located along the side of the optic frame 30516. These electrical/optical components 30542 may also be touch sensors that send signals to the computer when they sense contact from the user. In addition to or in place of touch sensors, these components 30542 could include cameras, speakers, microphones, or other electrical devices, depending on how the particular eyeglass device 30510 is arranged and what capabilities it is intended to have.

FIG. 9B shows that these components 30542 can be placed in many locations along the eyeglass frame 30512, including the side of the optic frame 30516, and along the side arm 30514. The electrical/optical components supported on the side arm 30514 can include slider sensors 30544 as well as touch sensors 30546. Touch sensors 30546 are shown as two alternating or staggered rows of discrete sensor strips. When the user touches the side arm 30514, the touch sensors 30546 staggered along the length of the side arm 30514 can identify where along the side arm the user has made contact. The sensor 30546 that the user touches sends a signal to the on-board computer, and the location of the sensor can indicate a particular command, such as turning on a camera or uploading a photograph. As another example, the user can move a finger along the length of the side arm 30514, along slider sensors 30544 or touch sensors 30546, to indicate a different type of command, such as to increase or decrease the volume of a speaker. The particular layout and location of electrical/optical components 30544, 30546 along the length of the side arm 30514 can be varied as desired.

FIG. 9C is a top view of the eyeglass frame 30512, showing that additional electronic components 30548, 30550 can be located along the top of the optic frames 30516 and side arms 30514, respectively. Additionally, as indicated in FIG. 9C, each side arm 30514 is connected to the respective optic frame 30516 by a hinge 30529. The hinge 30529 includes a pin 30531 about which the side arm 30514 rotates with respect to the optic frame 30516, to move the frame 30512 between open and folded positions. Various options for the hinge will be discussed in more detail below.

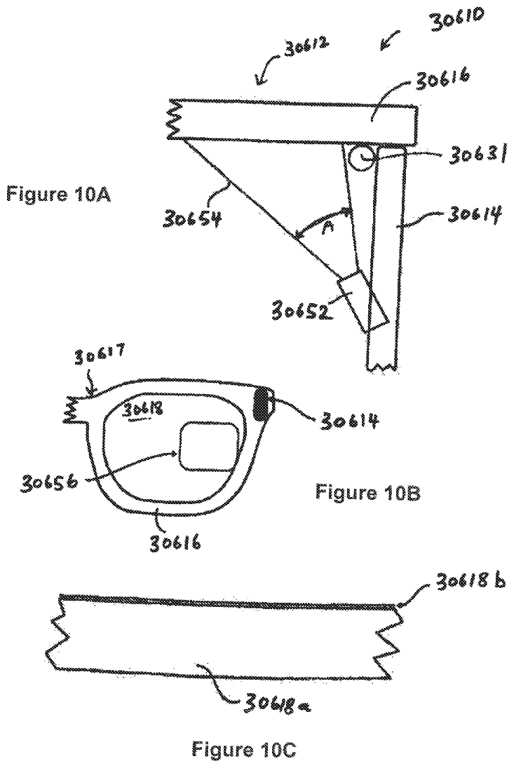

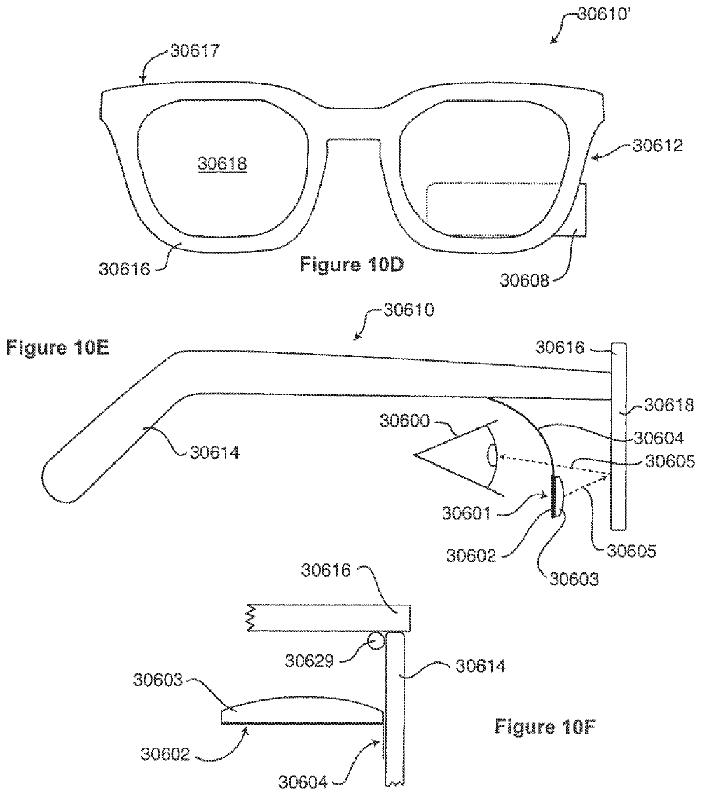

Another embodiment of the invention is shown in FIGS. 10A-10C. The eyeglass frame 30612 includes a projector 30652 mounted on the side arm 30614 and aimed toward the optic 30618 housed in the optic frame 30616. The projector 30652 transmits light 30654 through an angle A, and the light is reflected from the optic 30618 back to the wearer's eye. In this way the projector 30652 can project images that are viewable by the wearer. An embodiment of a projector system, including projector 30652, light 30654, and the reflection of this light by the optic 30618 to focus in the user's eye is described in more detail elsewhere in this application. In the projector system, the optic 30618 may be referred to as a “proximal optic”, and it may be incorporated into the optic of a pair of glasses such as the eyeglass device 30110, 30210, 30310, etc. disclosed in this application.

As shown in FIG. 10B, when the projector 30652 is operating, the wearer sees an image 30656 in the wearer's field of view. The image 30656 appears to be projected in front of the wearer's eye, through the optic 30618. The projected image 30656 in FIG. 10B is located toward the right side of the wearer's field of view, but this can vary in other embodiments. The projector 30652 can be designed to project the image 30656 at any desired place within the user's field of view. For some applications, it may be desirable to have an image 30656 directly in front of the wearer, but for many applications, it may be more desirable to project the image in the periphery of the user's vision. The size of the image 30656 can also be controlled by the projector.

The light from the projector 30652 is reflected, refracted, or otherwise redirected from the optic 30618 (such as a lens) into the eye of the wearer to cause an image to impinge on the retina; similarly, light reflected from the retina, including that projected, as well as light reflected from other portions of the eye can be captured for use as feedback on the position of the wearer's eye(s). FIG. 10C is a cross-section of the example lens 30618a indicating that it includes a coating surface 30618b, such as preferably on the inner surface. The coating preferably interacts with the projected light to send it into the pupil of the eye and/or return light from the eye to the camera. Coatings are known that reflect substantially limited portions of the visible spectra, such as so-called “dichroic” coatings. These coatings have the advantage that they limit the egress of light from the glasses and can, particularly with narrow “band-pass” design, interfere little with vision by the wearer through the glasses.

Another embodiment of the invention is shown in FIGS. 10D-10F. In this embodiment, an eyeglass device 30610′ includes a peripheral visual display system 30601. This visual display system is located at a periphery of the user's eye and displays images such as image 30608 (FIG. 10D) in the periphery of the user's vision. In one embodiment, the image 30608 is a low-resolution textual image, such as a text message, a temperature reading, a heart rate reading, a clock, or a news headline. The image is displayed by an illuminator 30602 and a lens 30603, which are mounted to the eyeglass frame 30612 and suspended away from the center of the user's field of view. The image 30608 may be quite small, to avoid interfering with the user's view. In one embodiment, the lens has a size of about 2 cm2. In one embodiment, the lens 30603 and illuminator 30602 are suspended from the side arm 30614 by a bridge 30604, which extends down from the side arm 30614.

The illuminator 30602 displays an image such as a text message. Light 30605 from the illuminator 30602 passes through the lens 30603 and toward the main optic 30618. The light from the illuminator is transmitted by the lens 30603, to send it toward the optic 30618. The lens 30603 compensates for the curve of the optic 30618 and the wearer's eyesight. In one embodiment, the lens 30603 is removable, such as by being snapped into or out of place. A kit with various lenses can be provided, and the user can select the lens that is appropriate for the user.

The light 30605 is then reflected by the optic 30618 and directed toward the user's eye 30600, as shown in FIG. 10E. In one embodiment, the optic 30618 or a portion of the optic 30618 does not have an anti-reflective coating, so that the light 30605 can be reflected as shown in FIG. 10E. In some embodiments, the optic includes dichroic or other structures that reflect a narrow band of frequencies, or narrow bands in the case of multi-color displays, in order to provide higher reflectivity for the wearer and/or block the image from view by onlookers. Modifications to the reflective characteristics of the inside of the optic 30618 can be accomplished by coatings, lenses, stickers, self-adhesive or adhered membranes, or other mechanisms.

Although not shown for clarity in FIG. 10F, there is optionally a space between the illuminator 30602 and lens 30603, such as a small gap of air, for the light from the illuminator to pass through before reaching the lens 30603. Also, while the illuminator 30602 is shown in the figures as a flat surface, it can be curved.

The bridge 30604 can be any suitable connecting member to mount the display system 30601 to the frame 30612. A metal or plastic piece can connect the lens 30603 and illuminating elements 30602 to the side arm 30614, or to the front face 30617. The material can be the same material used for the frame 30612. In one embodiment the bridge 30604 is rigid, to keep the display system 30601 properly aligned. In one embodiment, the bridge 30604 includes a damping element such as a damping spring to insulate the display system 30601 from vibrations from the frame 30612. In another embodiment, the bridge 30604 is a bendable member with shape memory, so that it retains its shape when bent into a particular configuration. In this way, the user can bend the bridge to move the display system 30601 out of the user's vision, to the side for example, near the side arm 30614, and then can bend the bridge again to bring the display system 30601 back into use. The bridge 30604 can be provided as a retrofit member, such that the system 30601 can be added to existing eyeglass frames as an accessory device. Mechanical means for attaching the system 30601 to the eyeglasses, such as by attaching the bridge 30604 to the side arm, can be provided, including snaps, clips, clamps, wires, brackets, adhesive, etc. The system 30601 can be electrically and/or optically coupled to the eyeglass device to which it is attached.

In one embodiment, the display system 30601 sits between the user's temple and the side arm 30614. The side arm 30614 can bend or bulge out away from the user's head, if needed, to accommodate the display system 30601. In another embodiment, the display system 30601 sits below the user's eye. In another embodiment, the lens 30603 is positioned behind the front surface of the user's eye.

There are many potential combinations of electrical/optical components, in different locations on the eyeglass frame, which interact together to provide many applications for the wearer. The following sections describe exemplary categories of electrical/optical components that can be used on the eyeglass device, including “infrastructure” components (computer processor, storage, power supply, communication, etc.), “input” devices (touch sensors, cameras, microphones, environmental sensors), and “output” devices (image projectors, speakers, vibrators, etc.). The various types of sensors described below are intended to be exemplary and non-limiting examples. The embodiments described are not intended to be limited to any particular sensing or other technology.

The “input” devices include electrical/optical components that take input such as information, instructions, or commands from the wearer, or from the environment. These devices can include audio input devices, such as audio transducers, microphones, and bone conduction devices, which detect audio sounds made by the user. These devices can detect voice commands as well as other sounds such as clapping, clicking, snapping, and other sounds that the user makes. The sound can be detected after it travels through the air to the audio device, or after it travels through the user's skull (in the case of bone conduction devices). The audio input devices can also detect sounds from the environment around the user, such as for recording video and audio together, or simply for transmitting background sounds in the user's environment.

Another type of input device detects eye movement of the wearer. An eye tracker can detect movement of the user's eye from left to right and up and down, and can detect blinks and pupil dilation. The eye tracker can also detect a lack of movement, when the user's eye is fixed, and can detect the duration of a fixed gaze (dwell time). The eye tracker can be a camera positioned on the eyeglass frame that detects reflections from the user's eye in order to detect movement and blinks. When the eyeglass frame includes an eye tracker, the user can give commands to the device simply by blinking, closing an eye, and/or looking in a particular direction. Any of these inputs can also be given in combination with other inputs, such as touching a sensor, or speaking a command.

Another category of input devices includes tactile, touch, proximity, pressure, and temperature sensors. These sensors all detect some type of physical interaction between the user and the sensors. Touch sensors detect physical contact between the sensor and the user, such as when the user places a finger on the sensor. The touch sensor can be a capacitive sensor, which works by detecting an increase in capacitance when the user touches the sensor, due to the user's body capacitance. The touch sensor could alternatively be a resistance sensor, which turns on when a user touches the sensor and thereby connects two spaced electrodes. Either way, the touch sensor detects physical contact from the user and sends out a signal when such contact is made. Touch sensors can be arranged on the eyeglass frame to detect a single touch by the user, or multiple finger touches at the same time, spaced apart, or rapid double-touches from the user. The sensors can detect rates of touch, patterns of touch, order of touches, force of touch, timing, speed, contact area, and other parameters that can be used in various combinations to allow the user to provide input and instructions. These touch sensors are commercially available on the market, such as from Cypress Semiconductor Corporation (San Jose, Calif.) and Amtel Corporation (San Jose, Calif.). Example capacitive sensors are the Analog Devices AD7142, and the Quantum QT118H.

Pressure sensors are another type of tactile sensor that detect not only the contact from the user, but the pressure applied by the user. The sensors generate a signal as a function of the pressure applied by the user. The pressure could be directed downwardly, directly onto the sensor, or it could be a sideways, shear pressure as the user slides a finger across a sensor.

Another type of tactile sensor is proximity sensors, which can detect the presence of a nearby object (such as the user's hand) without any physical contact. Proximity sensors emit, for example, an electrostatic or electromagnetic field and sense changes in that field as an object approaches. Proximity sensors can be used in the eyeglass device at any convenient location, and the user can bring a hand or finger near the sensor to give a command to the eyeglass device. As with touch sensors, proximity sensors are commercially available on the market.

Temperature sensors can also be mounted on the eyeglass frame to take input from the user, such as by detecting the warmth from the user's finger when the sensor is pressed. A flexure sensor, such as a strain gage, can also take input by the user by detecting when the user presses on the eyeglass frame, causing the frame to bend.

Another input device is a motion or position sensor such as an accelerometer, gyroscope, magnetometer, or other inertial sensors. An example is the Analog Devices ADIS16405 high precision tri-axis gyroscope, accelerometer, and magnetometer, available from Analog Devices, Inc. (Norwood, Mass.). The sensor(s) can be mounted on the eyeglass frame. The motion or position sensor can detect movements of the user's head while the user is wearing the glasses, such as if the user nods or shakes his or her head, tilts his or her head to the side, or moves his or her head to the right, left, up, or down. These movements can all be detected as inputs to the eyeglass device. These movements can also be used as inputs for certain settings on the eyeglass device. For example, an image projected from the eyeglass device can be fixed with respect to the ground, so that it does not move when the user moves his or her head, or it can be fixed with respect to the user's head, so that it moves with the user's head and remains at the same angle and position in the user's field of view, even as the user moves his or her head.

The eyeglass device can also include standard switches, knobs, and buttons to obtain user input, such as a volume knob, up and down buttons, or other similar mechanical devices that the user can manipulate to change settings or give instructions. For example, a switch on the side arm can put the eyeglass device into sleep mode, to save battery life, or can turn a ringer on or off, or can switch to vibrate mode, or can turn the entire device off.

Another type of input devices is environmental sensors that detect information about the user's environment. These can include temperature sensors mounted on the eyeglass frame to detect the surrounding ambient temperature, which could be displayed to the user. Another sensor could detect humidity, pressure, ambient light, sound, or any other desired environmental parameter. An echo sensor can provide information through ultrasonic ranging. Other sensors can detect information about the wearer, such as information about the wearer's health status. These sensors can be temperature sensors that detect the wearer's temperature, or heart rate monitors that detect the wearer's heart beat, or pedometers that detect the user's steps, or a blood pressure monitor, or a blood sugar monitor, or other monitors and sensors. In one embodiment, these body monitors transmit information wirelessly to the eyeglass device. Finally, another type of environmental sensor could be location sensor such as a GPS (global positioning system) receiver that receives GPS signals in order to determine the wearer's location, or a compass.

Finally, input devices also include cameras of various forms, which can be mounted as desired on the eyeglass frame. For example, an optical camera can be positioned on the front of the optic frame to face forward and take images or videos of the user's field of view. A camera could also be faced to the side or back of the user, to take images outside the user's field of view. The camera can be a standard optical camera or an infrared, ultra-violet, or night vision camera. The camera can take input from the user's environment, as well as from the user, for example if the user places a hand in front of the camera to give a command (such as to turn the camera off), or raises a hand (such as to increase volume or brightness). Other gestures by the user in front of the camera could be recognized as other commands.

The next category of electrical/optical components that can be included in various embodiments of the eyeglass device are output devices. Output devices deliver information to the wearer, such as text, video, audio, or tactile information. For example, one type of output device is an image projector, which projects images into the wearer's eye(s). These images can be still or video images, including email, text messages, maps, photographs, video clips, and many other types of content.

Another type of output device is audio transducers such as speakers or bone conduction devices, which transmit audio to the wearer. With the ability to transmit audio to the wearer, the eyeglass device can include applications that allow the wearer to make phone calls, listen to music, listen to news broadcasts, and hear alerts or directions.

Another type of output device is tactile transducers, such as a vibrator. As an example, the eyeglass device with this type of transducer can vibrate to alert the user of an incoming phone call or text message. Another type of output device is a temperature transducer. A temperature transducer can provide a silent alert to the user by becoming hot or cold.

The next category of electrical/optical components includes infrastructure components. These infrastructure components may include computer processors, microprocessors, and memory devices, which enable the eyeglass device to run software programming and store information on the device. The memory device can be a small hard drive, a flash drive, an insertable memory card, or volatile memory such as a random access memory (RAM). These devices are commercially available, such as from Intel Corporation (Santa Clara, Calif.). The computer system can include any specialized digital hardware, such as gate arrays, custom digital circuits, video drivers, digital signal processing structures, and so forth. A control system is typically provided as a set of programming instructions stored on the computer processor or memory device, in order to control and coordinate all of the different electrical/optical components on the eyeglass device.

Infrastructure devices can also include a power source, such as on-board batteries and a power switch. If the batteries are re-chargeable, the eyeglass device can also include the necessary connector(s) for re-charging, such as a USB port for docking to a computer for recharging and/or exchanging content, or a cable that connects the device to a standard wall outlet for recharging. Exemplary re-charging components are described in more detail below.

The infrastructure devices can also include communications devices such as antennas, Bluetooth transceivers, WiFi transceivers, and transceivers and associated hardware that can communicate via various cellular phone networks, ultra-wideband, irDA, TCP/IP, USB, FireWire, HDMI, DVI, and/or other communication schemes. The eyeglass can also include other hardware such as ports that allow communications or connections with other devices, such as USB ports, memory card slots, other wired communication ports, and/or a port for connecting headphones.

Additionally, the eyeglass device can include security devices such as a physical or electronic lock that protects the device from use by non-authorized users, or tamper-evident or tamper-responding mechanisms. Other security features can include a typed or spoken password, voice recognition, and even biometric security features such as fingerprints or retina scanning, to prevent unauthorized use of the device. If an incorrect password is entered or a biometric scan is failed, the device can send out alerts such as an audio alarm and an email alert to the user.

The eyeglass device can also include self-monitoring components, to measure its own status and provide alerts to the user. These can include strain gages that sense flexure of the eyeglass frame, and sensors to detect the power level of the batteries. The device can also have other accessory devices such as an internal clock.

Additionally, the “infrastructure” components can also include interfaces between components, which enable parts of the device to be added or removed, such as detachable accessory parts. The device can include various interfaces for attaching these removable parts and providing power and signals to and from the removable part. Various interfaces are known in the art, including electrical, galvanic, optical, infrared, and other connection schemes.

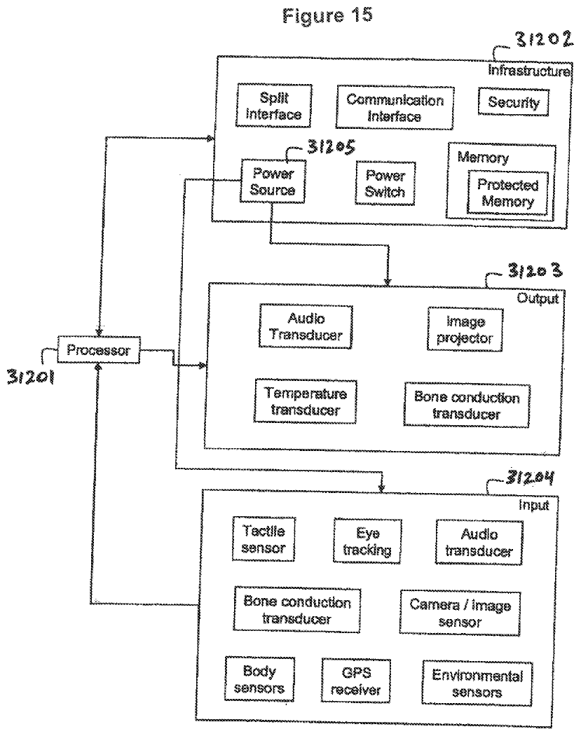

FIG. 15 is a block diagram showing exemplary infrastructure, output, and input devices. A processor 31201 communicates back and forth with infrastructure devices 31202. The processor 31201 sends information to output devices 31203, and receives information from input device 31204. All of the devices are connected to a power source 31205, which can supply electrical or optical power to the various devices.

The system may also utilize protected program memory, as shown in FIG. 15. The firmware and/or software controlling the systems on each integrated device preferably contains cryptographic algorithms that are used to verify signatures on code updates and/or changes and preferably to decrypt same using keying matter that is securely stored and used. The use of cryptographic algorithms and encrypted programs can make it difficult for malicious software or users to interfere with operation of the system.

These various electrical/optical components can be mixed and matched to create a particular eyeglass device with the desired capabilities for the wearer. For example, an eyeglass device with an audio speaker, microphone, touch sensors, image projector, wifi connection, on-board processor, memory, and batteries can be used to browse the Internet, and download and send email messages. The computer can make a sound, such as a chime sound, when the user receives a new email, and the user can state a command, such as the word “read,” to instruct the device to display the new email message. The image projector can then display the new email message. The user can then respond to the email by typing a new message via the touch sensors, and then can state “send” or some other command to send the email. This is just one example, and there are many possible combinations of input, output, and content. The wearer can customize his or her eyeglass device to take commands in a particular way (voice, tactile, eye tracking, etc.) and to provide alerts and information in a particular way (displaying an icon, making a chime sound, vibrating, etc.). The particular content that is provided can be customized as well, ranging from email, text messages, and web browsing to music, videos, photographs, maps, directions, and environmental information.

As another example, the user can slide a finger along the sensors 30544 or 30546 on the side of the side arm 30514 to increase or decrease the volume of music or audio playback. The user can circle a finger around the sensors 30540 on the front of the optic frame 30516 to focus a camera, darken or lighten an image, zoom in on a map, or adjust a volume level. The user can type on the sensors 30546 or 30542 (see FIG. 9B), tapping individual sensors or even tapping sensors together in chords, to type an email or select a song or provide other instructions. The user can grasp the side arm between thumb and finger to have the sensors on the side of the side arm act as a keyboard. One sensor at a certain position can even act as a shift key for the user to press, to have additional inputs. Given these dynamic controls, the image projector can display the control options to the user so that he or she knows which sensors correspond to which inputs. The user can slide a finger along the side of the side arm to scroll up or down a webpage that is displayed by the image projector. The image projector can display an email icon when a new email arrives, and the user can look at this icon and blink in order to have the email opened and displayed. The user can press a button and state the word “weather”, and the image projector will display current weather information from the on-board environmental sensors and/or from the Internet. The user can make a clicking sound to select an icon or bring up a home page.

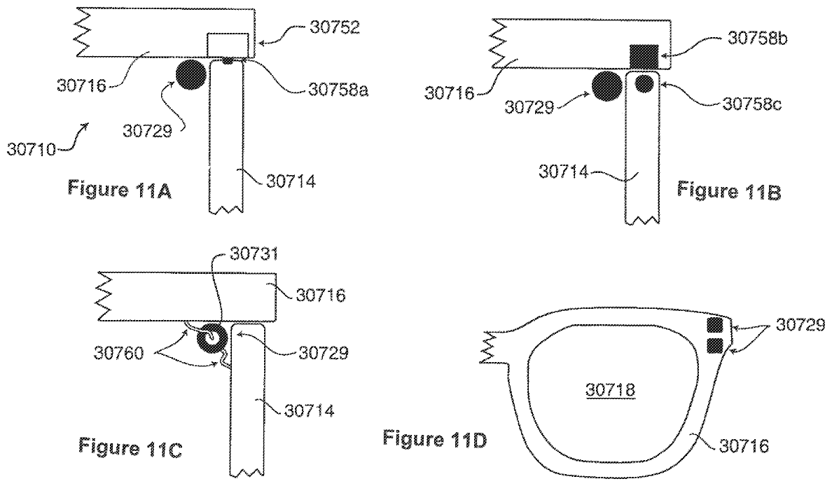

Exemplary features of the eyeglass device will now be described. In the embodiment of FIG. 11A, the eyeglass frame 30712 includes a hinge 30729 that connects the side arm 30714 and optic frame 30716. In this embodiment, a power switch 30758 is mounted on the optic frame 30716 to interact with the side arm 30714. When the side arm 30714 is rotated about the hinge 30729 into the open position (shown in FIG. 11A), the side arm 30714 depresses a button 30758a extending from the switch 30758. When the button is depressed, power is supplied to the electrical/optical components on the eyeglass frame 30712. When the wearer is finished using the eyeglass device, he or she removes the eyeglass frame 30712 and rotates the side arm 30714 about the hinge 30729 into a folded position, for storage. The side arm 30714 moves away from the switch 30758, releasing the button 30758a. When the button is released, power is disconnected from the electrical/optical components. The button can be spring-loaded to return to the released position, disconnecting power, when the eyeglass frame is folded. Switches of this type are commercially available, such as the DH Series switches manufactured by Cherry/ZF Electronics Corporation (Pleasant Prairie, Wis.) or the D2SW-P01H manufactured by Omron Corporation (Japan).

In one embodiment, a single switch such as switch 30758 is provided at one hinge 30729. In another embodiment, two switches 30758 are provided, one at each hinge 30729, and power is connected to the device only when both side arms 30714 are rotated into the unfolded, open orientation.

FIG. 11A is one example of a power switch, and the switch could take other forms. For example, in FIG. 11B, the power switch 30758′ is a reed switch, which includes switch 30758b and magnet 30758c. When the side arm 30714 is unfolded, the magnet 30758c is near the switch 30758b. The magnet closes the switch, which then provides power to the eyeglass frame. When the side arm 30714 is folded, the magnet 30758c rotates away from the switch 30758b, and the switch is opened and power disconnected. In other embodiments, the power switch for the eyeglass frame is not associated with the hinge, but is located on a different area of the eyeglass frame. The power switch can be a mechanical switch manipulated by the user, or an electronic switch or sensor. Electronic switches typically require some backup power even when the device is off, much like a sleep mode, in order for them to operate.

FIG. 11C shows how power and signals can be transferred between the side arm 30714 and optic frame 30716. In the embodiment shown, the hinge 30729 includes a hollow pin 30731 about which the side arm 30714 rotates. One or more wires or cables 30760 pass from the optic frame 30716, through the center of this hollow pin 30731, to the side arm 30714. In this way, power and signals can travel between the side arm 30714 and optic frame 30716 even when they are separated by the hinge 30729. The cables can be electrical cables and/or fiber optic cables for transmitting light. In other embodiments, other mechanisms for transferring power and signals through the hinge can be used, such as slip ring, which keeps the side arm 30714 in communication with the optic frame 30716 even as the side arm 30714 rotates about the hinge. Further exemplary embodiments of a hinge arrangement are described below.

FIG. 11D shows an embodiment in which the hinge 30729 is formed with two separate hinge parts. The hinge from the side arm 30714 fits between these two separate parts to complete the hinge. At certain angular positions, the hinge allows power or signals to pass through the hinge, and at other angular positions the hinge interrupts the power or signals. The two hinge components on the optic frame 30716 are insulated from each other, with the power or signal passing through the cooperating hinge on the side arm 30714. In one embodiment, the hinge 30729 acts as a slip ring, transferring power or signals, without acting as a switch. In other embodiments, the hinge acts as a switch, and in other embodiments, it provides both functions.

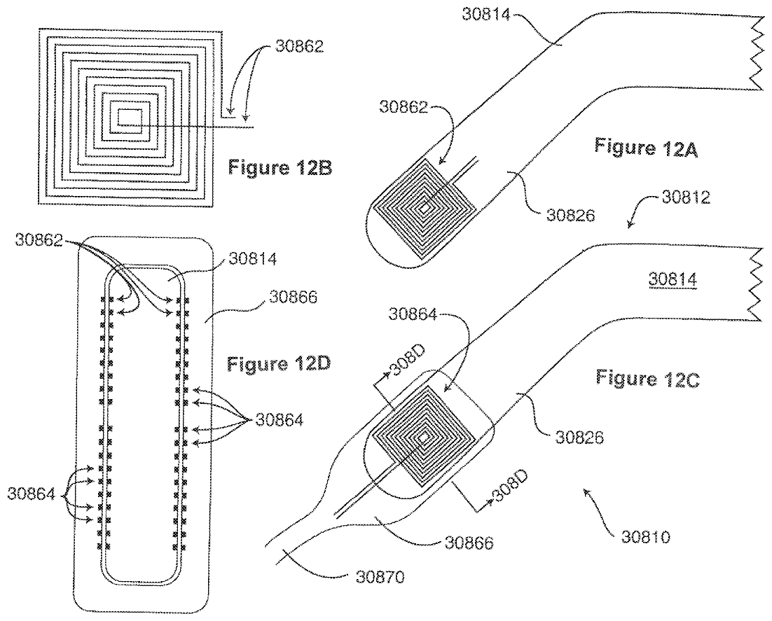

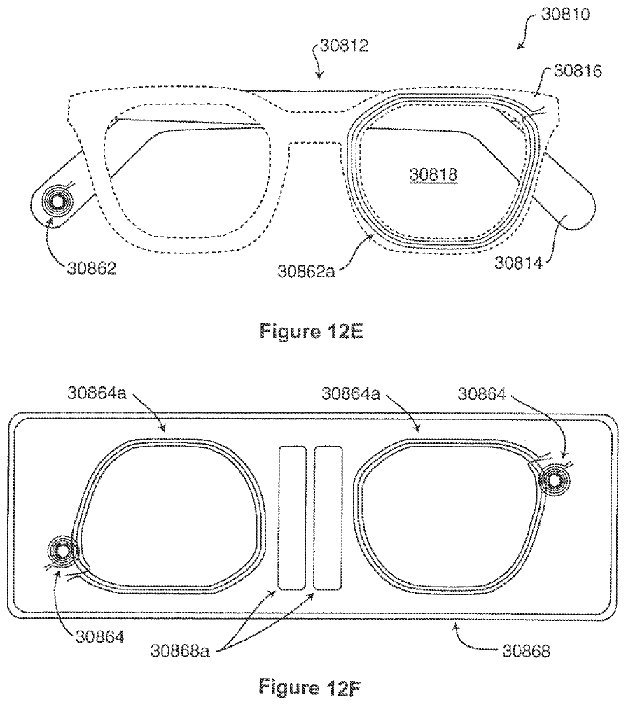

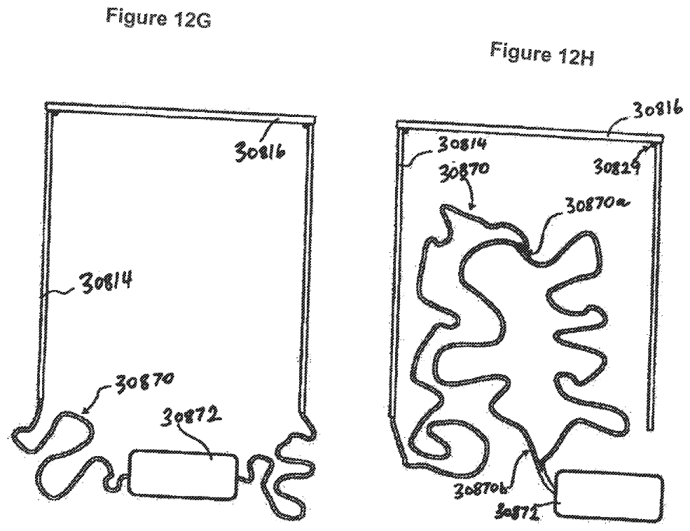

FIGS. 12A-12F show embodiments of the invention in which an eyeglass device 30810 communicates power and/or signals through one or more coils disposed on the eyeglass frame 30812. Alternatively, the eyeglass device communicates power and/or signals through capacitive surfaces on the eyeglass frame 30812. For example, as shown in FIG. 12A, the side arm 30814 includes a coil structure 30862 located at the end of the side arm, at the end of the ear hook 30826. An enlarged view of this coil 30862 is shown in FIG. 12B. This coil 30862 interacts with a separate coil in a charging device, such as coil 30864 in boot 30866, as shown in FIG. 12C. The boot 30866 fits over the end of the ear hook 30826, positioning its own coil 30864 in close proximity with the first coil 30862 on the side arm 30814. A cross-sectional view is shown in FIG. 12D, to show the proximity of the two coils 30862, 30864. In the embodiment shown, the side arm 30814 includes a coil 30862 on each side surface of the side arm, and the boot 30866 also has two coils 30864 on each inside surface of the boot. The boot 30866 may be made of an elastic material, so that it stretches over the ear hook 30826 and remains in place due to the elasticity of the boot 30866 itself. Friction between the boot 30866 and ear hook 30826 can also hold the boot in place, or the boot can be retained by other means such as snaps, hooks, magnets, loops, etc.

When the coils 30862, 30864 face each other in close proximity, as shown in FIG. 12D, the eyeglass device 30812 can be charged through inductive charging. The coil 30864 in the boot 30866 is connected to a power supply, such as an alternating current electrical power outlet. The electrical current flowing through the coil 30864 creates an alternating electromagnetic field. The coil 30862 in the eyeglass side arm 30814 converts this electromagnetic field back into electrical current to charge the batteries on-board the eyeglass frame 30812. By placing the two coils 30862, 30864 in close proximity, this charging can take place without any direction contact between the two coils. Information signals can also be passed from the boot 30866 to the eyeglass frame 30812 by modulating the current and the electromagnetic field or other means known in the art.

The location of the coil 30862 on the eyeglass frame 30812 is not limited to the end of the side arm 30812. As shown in FIG. 12E, another coil 30862a can be provided on one or both optic frames 30816, encircling the optic 30818. This optic coil 30862a interacts with a corresponding coil 30846a which can be located, for example, in a storage case 30868 (see FIG. 12F). When the eyeglass device 30812 is not in use, or when it needs to be charged, it is placed in the case 30868 with the optic coil 30862a on the eyeglass frame facing the coil 30864a in the case 30868. The case 30868 has its own power connectors 30868a that provide power to the case, such as by connecting it to a wall outlet and/or information infrastructure or device, and the eyeglass device can be charged by inductive charging through the coils 30864a, 30862a.

In the embodiment shown in FIG. 12F, the case 30868 has optic coils 30864a on both sides of the case, so that the charging can take place regardless of which way the eyeglass frame 30812 is placed in the case. Alternatively, only one coil 30864a can be included in the case 30868, and the user will simply need to place the eyeglass frame 30812 in the proper orientation so that the coils 30862a, 30864a face each other. In another alternate embodiment, coils 30862a can be provided around both optic frames 30816, although only one is shown in FIG. 12E-12F.

In the embodiment shown in FIG. 12F, the case 30868 also includes smaller coils 30864 that interact with the coil 30862 at the end of the side arm 30814. Thus, the coil 30864 can be provided in the charging case 30868 or in a boot 30866 that fits over the side arm 30814. Four coils 30864, 30864a are shown in the case 30868 in FIG. 12F, in order to allow for the eyeglass device to couple with the coils regardless of the orientation of the eyeglass frame in the case 30868 (upside down, facing forward, flipped left-for-right). Any orientation of the frame in the case allows coupling. However, in other embodiments, less than four coils are provided in the case 30868. Four, three, two, or even just one coil may be provided, in which case the eyeglass frame 30812 will couple with the coil when stored in the appropriate orientation in the case 30868.

The coils 30862, 30864 can pass power and communication signals to the eyeglass frame through inductive charging, as just described. As another example, the eyeglass device can communicate by capacitive charging, by placing capacitive surfaces in proximity and/or in contact with each other. Also, the eyeglass frame 30812 can include a connection for direct coupling with a charging device. The eyeglass frame can have a male or female connector that connects with a corresponding male or female connector on a charging device, to provide electrical current through direct wired contact.

In addition to charging the eyeglass device 30810, the case 30868 can transfer signals to the eyeglass device 30810, such as updating clocks and calendars, or uploading or downloading content. The case 30868 can act as a base station, and the eyeglass frame 30810 can be placed in the base for docking synchronization and data transfer.

In one embodiment, the boot 30866 is formed as the end of a lanyard or cord 30870 that connects to the other side arm 30814, forming a loop with the eyeglass frame 30812, as shown for example in FIGS. 12G-12H. In the embodiment of FIG. 12G, the lanyard 30870 connects the two side arms 30814, and also connects to a package 30872. The package 30872 can include, for example, electrical/optical components that interact with the eyeglass frame 30812 but are not mounted on the eyeglass frame. For example, the package 30872 can include batteries that re-charge the batteries on-board the eyeglass frame 30812. When batteries onboard the frame 30812 need recharging, or when the eyeglass device 30810 needs to be powered, the lanyard 30870 can be connected, to transmit power from the batteries in the package 30872 to the frame 30812. The lanyard 30870 can transmit this power through inductive charging or direct contact, as described above. The lanyard itself may include power cables, electrical wires, and/or fiber optic cables for transmitting power and signals between the package and the eyeglass frame. The lanyard can even act as an antenna itself.

In other embodiments, the package 30872 can include other electrical/optical components, such as accessory devices that the user can connect when desired. For example, the package 30872 can include an MP3 player or radio transceiver that the user connects via the lanyard 30870 in order to listen to music, and then disconnects and stores for later use. The package 30872 could include a GPS receiver that the user can use when desired, and then stores when not in use. The package can include a light source for use with an image projector, such as projector 30652. The package can include a computer processor, hard drive, memory, and other computer hardware. The package can include audio microphones to augment sound capture, and/or additional touch panel surfaces for user input. The user can touch the package 30872 and receive feedback from the eyeglass device 30810.

In another embodiment, the package 30872 includes electrical/optical components that communicate wirelessly with the eyeglass frame 30812, such as by radio frequency, optical, audio, or other means. In this embodiment, the lanyard 30870 may mechanically connect to the side arms 30814 without any inductive coils or any direct electrical connection, as the communication between the package 30872 and the frame 30812 is done wirelessly. In this case, the package 30872 could even be separate from the eyeglass frame 30812 entirely, perhaps carried on the user's belt or wristwatch, or in a backpack or purse, or even as a skin patch.

FIG. 12H shows another embodiment in which the lanyard 30870 attaches to only one side arm 30814, and a connector 30870a forms the lanyard into a loop or necklace 30870b that the user can wear or loop around another item as is convenient. The package 30872 is carried on the loop 30870b. In one embodiment, the package 30872 is decorative, and provides an anchor for the lanyard 30870.

The lanyard 30870 can attach to the eyeglasses with a boot, such as boot 30866, that slides over and surrounds the end of the side arm 30814. Alternatively, the lanyard can attach with simple rubber clips that slide over the end of the side arm, or with magnet, or other mechanical hooks. In another embodiment, the lanyard is permanently connected to the side arm 30814, rather than being removable.

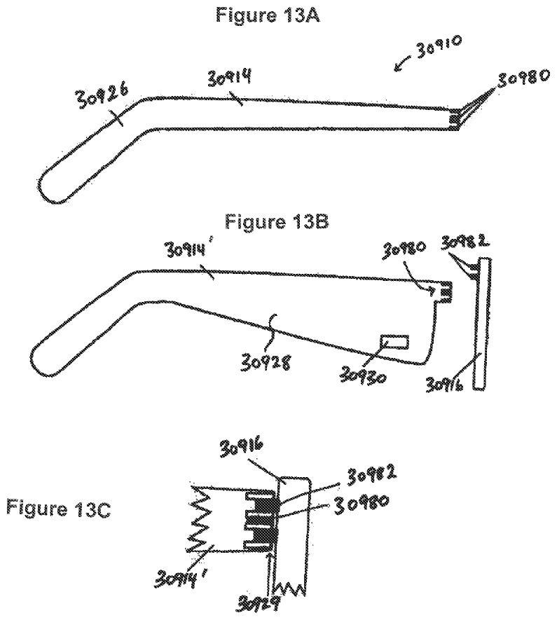

The eyeglass device of the present invention can be formed as interchangeable components that can be swapped or switched out as desired. For example, in the embodiment of FIGS. 13A-13C, the side arm 30914 can be detached from the hinge 30929, and a replacement side arm 30914′ with one or more different electrical/optical components 30930 can be attached. This feature enables the user to switch outside arms to provide different capabilities, as desired. For example, the electrical/optical components 30930 on the replacement side arm 30914′ can provide capabilities that the user needs only in certain situations, such as a night-vision camera, or a GPS receiver, or other electrical devices with their own unique capabilities. The user can select between a set of various different replacement side arms, depending on which electrical/optical components and capabilities the user needs for a given situation. In one embodiment, a replacement side arm may not have any electrical/optical components, or may have the same functionality as another side arm, but it provides a different style or color or decorative function.

As shown in FIGS. 13A-13B, clips 30980 on the side arms 30914, 30914′ connect to projections 30982 on the optic frame 30916 to form the hinge 30929. An enlarged view of this connection is shown in FIG. 13C. The projections 30982 fit between the clips 30980 and can rotate between them, allowing the side arm 30914, 30914′ to rotate between folded and extended positions. The hinge 30929 can pass power and signals between the side arm 30914 and optic frame 30916 through the connections between the clips 30980 and projections 30982. The clips 30980 are spaced apart from each other with an insulating material, to prevent a short circuit between the electrical paths provided on the clips. The projections 30982 are similarly spaced. When the clips and projections are snapped together, they form electrical paths between them so that power and signals can be transmitted through the hinge. The clips and projections may also be referred to as hinge knuckles, which mate together to form the rotating hinge. The clips and projections can be snapped together by mating a ball into a curved cavity between each clip and projection (not shown for clarity), with the outer projections deflecting out and then snapping back into place to receive the clips in between.

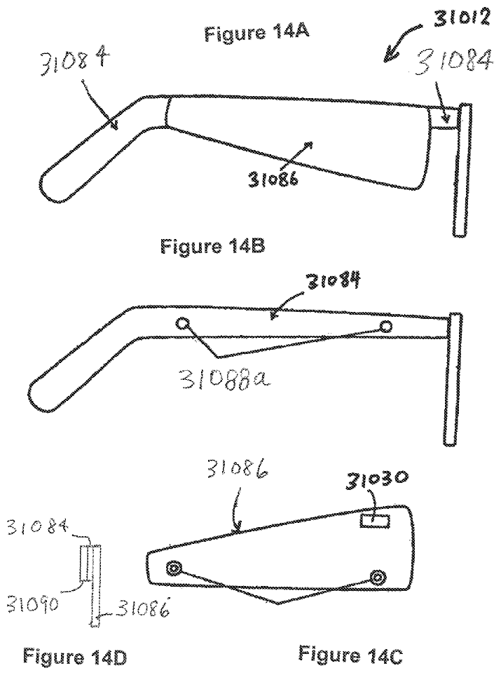

In another embodiment, an eyeglass device 31012 is formed by providing a separate attachment unit 31086 that is fastened to a pair of traditional eyeglasses 31084, as shown in FIGS. 14A-14D. In this embodiment, a standard pair of eyeglasses can be retrofitted to provide new capabilities, without having to replace the user's existing eyeglasses. The separate attachment unit 31086 can be attached to the eyeglasses 31084 by fasteners 31088, such as magnets, clips, snaps, clamps, or corresponding male and female fasteners 31088a, 31088b, or by hooking the attachment unit over the eyeglass arm with a hook 31090 (see FIG. 14D). The attachment unit 31086 is shown flipped top over bottom in FIG. 14C, to reveal the fasteners 31088b that mate with the fasteners 31088a on the side arm of the eyeglasses 31084. The attachment unit 31086 can also be attached to an electronic eyeglass device, for example, device 30810 (rather than a traditional pair of glasses 31084) to provide additional utilities to the electronic eyeglass device. In this case, the attachment unit 31086 may also couple to exchange power and signal with the electronic eyeglass device 30810.

The separate attachment unit 31086 includes electrical/optical components 31030 as described before, such as touch sensors, audio transducers, image projectors, cameras, wireless antennas, and any of the other components described above, which enable the user to have the desired mobile capabilities, without replacing the user's existing eyeglasses 31084. Attachment units 31086 can be attached to one or both side arms and/or optic frames of the existing eyeglasses 31084, or attached via a lanyard.

I claim:

1. An eyeglass device comprising:
an eyeglass frame having a pair of side arms and a pair of optics;
a camera and one or more speakers supported by the eyeglass frame; and
a touch sensor for at least controlling volume of the one or more speakers supported by the eyeglass frame.

2. The device of claim 1, wherein the touch sensor is on one of the pair of side arms.

3. In an eyeglass device comprising an eyeglass frame, a pair of optics, and a pair of side arms, the eyeglass including a camera and/or one or more speakers, the improvement comprising at least one touch sensor on the eyeglass frame for controlling at least one of the camera and the one or more speakers.

4. The device of claim 3, wherein the touch sensor is on one of the pair of side arms.

5. The device of claim 3, wherein the eyeglass frame includes a camera.

6. The device of claim 3, wherein the eyeglass frame includes one or more speakers.

7. The device of claim 6, wherein the eyeglass frame includes a camera.

8. A method of at least controlling sound from one or more speakers on an eyeglass frame of an eyeglass device comprising:
a) providing the eyeglass device of claim 1,
b) donning the eyeglass device on a user, and
c) touching the touch sensor to at least control a volume of sound from the one or more speakers.
